(19) United States
(12) Patent Application Publication
(10) Pub. No.: US 2026/0330107 A1
(43) Pub. Date: Oct. 22, 2026

(54) SYSTEM FOR MODELING THE THREE-DIMENSIONAL BEHAVIOR OF LAMINAR AND TURBULENT FLOWS IN REAL TIME

(71) Applicants: Ariel Orlando ESPINOZA JARA, La Florida (CL); Pontificia Universidad Católica de Chile, Santiago (CL)

(72) Inventor: Ariel Orlando ESPINOZA JARA, La Florida (CL)

(21) Appl. No.: 19/720,283

(22) Filed: Jun. 25, 2026

Related U.S. Application Data
(63) Continuation of application No. PCT/CL2024/050178, filed on Dec. 26, 2024.

(30) Foreign Application Priority Data
Dec. 28, 2023 (CL) 202303963

(51) Int. Cl. G06F 30/27; G01N 11/02; G01N 29/44; G06F 111/10

(52) U.S. Cl. CPC G06F 30/27; G01N 11/02; G01N 29/4481; G06F 2111/10

(57) ABSTRACT

A system and method is provided for modeling three-dimensional behavior of laminar and turbulent flows in a containment medium in real time. At least one ultrasonic image capture unit captures at least a first image and at least a second consecutive image of at least one particle-laden fluid, through at least one of the walls of the fluid containment medium. At least one central unit obtains at least one radiofrequency value for the at least one first and second images, from which at least one velocity field of the at least one fluid is obtained. The at least one central unit includes at least one trained and optimized neural network based on real-time measurements in at least one volume of the at least one fluid, which receives the at least one two-dimensional velocity field to adjust its accuracy, and to model at least one three-dimensional velocity field in real time.

The present invention relates to a system and method for modeling the three-dimensional behavior of laminar and turbulent flows loaded with particles in a containment medium in real time, intended for applications and industries such as the mining, food, chemical, and process sectors in general, where there is a need to accurately measure the fluid velocity field, in order to determine the most likely failure zones due to wear caused by turbulence in the containment medium or in the medium transporting the fluid.

The system and method of the invention operate through the use of techniques to obtain ultrasound images in conjunction with neural networks trained with simulations and validated with previous measurements, allowing the system to not only obtain the two-dimensional velocity field of the area covered by the ultrasound images but also to model the velocity field in three dimensions for volumes much larger than those covered by said images.

In this regard, the system of the invention essentially comprises at least one ultrasonic image capture unit, which captures at least a first image and at least a second consecutive image of at least one particle-laden fluid, through at least one of the walls of the fluid containment medium; and at least one central unit for generating and receiving ultrasonic signals and processing data, which receives the at least one first and second images from the at least one ultrasonic image capture unit; wherein the at least one central unit for generating and receiving ultrasonic signals and processing data obtains at least one radiofrequency value for the at least one first and second images, from which at least one velocity field of the at least one fluid is obtained, through a displacement correlation of said at least one radiofrequency value, being adjusted said at least one radiofrequency value by the Doppler effect, generating at least one validated two-dimensional velocity field in real time; and wherein the central unit for generating and receiving ultrasonic signals and processing data comprises at least one trained and optimized neural network based on real-time measurements in at least one volume of the at least one fluid, which receives the at least one two-dimensional velocity field to adjust its accuracy, and to model at least one three-dimensional velocity field in real time.

On the other hand, the method of the invention essentially comprises the steps of: capturing at least a first image and at least a second consecutive image of at least one particle-laden fluid, through at least one of the walls of the fluid containment medium by means of at least one ultrasonic image capture unit; receiving, by at least one central unit for generating and receiving ultrasonic signals and processing data, the at least one first and second images from the at least one ultrasonic image capture unit; obtaining, through the at least one central unit for generating and receiving ultrasonic signals and processing data, at least one radiofrequency value for the at least one first and second images, from which at least one velocity field of the at least one fluid is obtained, through a displacement correlation of said at least one radiofrequency value, being adjusted said at least one radiofrequency value by the Doppler effect, generating at least one validated two-dimensional velocity field in real time; and receiving the at least one two-dimensional velocity field, through at least one neural network trained based on real-time measurements in at least one volume of the at least one fluid, to adjust its accuracy, and to model at least one three-dimensional velocity field in real time.

From the system and method of the invention, it is possible to model the behavior of the fluid in a significantly larger domain than measured, thus expanding local real-time measurement, but without sacrificing accuracy, which allows obtaining more detailed measurements of velocity fields compared to current systems.

### BACKGROUND

In the various industries that involve processes related to the transport, storage, or treatment of fluids, it is common to use technologies that allow the measurement of the velocity profile, such as flowmeters. These devices are generally used in applications that involve transporting the fluid through pipes, being placed near the elbows of the piping circuit to computationally model the velocity field that allows determining areas of high turbulence, thus detecting areas subjected to greater wear due to the direct projection of particles onto the wall of the pipe elbow. Turbulence corresponds to a complex and chaotic phenomenon that directly affects key processes such as fluid mixing, heat transfer, and component wear.

In this regard, current solutions have a series of problems that have not been addressed. One of them relates to the need to measure the velocity field and improve accuracy when predicting and controlling the behavior of a turbulent flow in real time, where such solutions must consider efficiency and cost, which are key in the industry.

On the other hand, current systems do not allow precise information to be obtained in real time, thus delaying the delivery of information to operators or those in charge of industrial processes, thereby preventing operators from making real-time decisions for process optimization or for performing predictive, preventive, or corrective maintenance.

Finally, there is another problem that current solutions have not been able to address, which relates to the modeling of turbulent flows in straight pipes and their wear. Although flowmeters operate relatively well in straight sections of a piping circuit, determining average velocity profiles and allowing for wear determination in adjacent elbow areas through subsequent simulations, these devices are not capable of operating accurately in straight sections of the pipe to obtain turbulence within it in real time, where there is also a significant effect of fluid turbulence on the wear of said pipe, which cannot be measured through these current solutions.

Therefore, there is a growing need not only for a system and method that allows improving accuracy and the delivery of real-time information regarding the velocity field of a fluid in a particular section of a pipe, equipment, or container, to locate areas of greater turbulence, but also for a solution that allows operating accurately at any point in the piping circuit, equipment, or container.

In the field of patents, there are solutions aimed at devices or systems for measuring the behavior of turbulent flows in a containment medium. For example, U.S. Pat. No. 9,383,237B2 describes a fluid visualization and characterization system, which includes a measurement section with a housing that defines a fluid flow path for the fluid flow to be analyzed. The measurement section includes one or more transducers to emit ultrasonic signals in the fluid flow and at least one receiver to receive reflections of the ultrasonic signal from reflectors in the fluid flow. The system includes memory to store data and a processor operatively connected to the memory. The processor consists of several modules. A velocity estimation module is configured to apply one or more velocity estimation algorithms to the reflections received from the ultrasonic signal, or data indicative of the same, to determine a velocity profile of the fluid flow. A deconvolution module is configured to apply a deconvolution algorithm at least to the determined velocity profile, to obtain a true velocity profile of the fluid flow. A fluid visualization and characterization module is configured to determine the characteristics of the fluid and/or the fluid flow using the determined velocity profile and/or the true velocity profile.

In this regard, document U.S. Pat. No. 9,383,237B2, while describing a system that allows obtaining the velocity profile in real time for laminar and turbulent flows, does not make any reference to the possibility of detecting turbulence zones on the surface of a pipe or equipment, where the probability of wear is higher. Furthermore, this document also does not describe the use of ultrasound images, nor the use of a trained and optimized neural network in its calculations (document U.S. Pat. No. 9,383,237B2 uses a variety of algorithms for calculating velocity profiles, which do not feed back into the system). Therefore, this document fails to address the issues associated with providing more detailed velocity profiles, based on the collection of greater information per unit of time and space, which allows for precise and complete measurements of the global velocity field in real time. Additionally, patent U.S. Pat. No. 9,383,237B2 also does not describe or suggest its use in measuring turbulent flow in straight pipes, an issue also addressed by the present invention, given that the system operates through ultrasound images.

Other examples within the technical field of the invention correspond to patent applications WO2001069231A1, US20220170850A1, and US20070078610A1, which describe different systems and methods for characterizing, monitoring, and analyzing fluids. Although these documents belong to the technical field of the present invention, they also fail to provide a solution to the problems raised in this application, since none of them use ultrasound images to obtain a first velocity field, which is subsequently analyzed by a trained and optimized neural network, from which a global velocity field in real time is obtained regarding a volume much larger than that circumscribed in the images. This is possible because the present system is capable of collecting a greater amount of information per unit of time and space, thus allowing for an increase in precision regarding the localization of turbulent zones. Furthermore, none of these documents describe or suggest their use in straight pipes, which is another advantage of the present invention, as mentioned earlier.

In this sense, the solutions described by all these documents are the technological basis of current systems, which only measure velocity profiles in two dimensions, not allowing for the measurement of turbulent fields or velocity fields in three dimensions. For its part, the present invention uses image correlations, from which, with the help of neural networks trained with CFD (Computational Fluid Dynamics) calculations validated with the same measurements of the velocity field, it allows modeling or predicting the behavior of the flow in three dimensions. That is, measurements from ultrasonic images enter the already trained neural network, which outputs the three-dimensional velocity vector field, no longer from a single “measurement line,” as current equipment does, nor from an “area of measurement,” as other state-of-the-art solutions do, but from a determined volume. From obtaining this vector field, it is possible to obtain existing metrics for the study and analysis of turbulence, such as turbulent kinetic energy and coherent structures within the measurement volume, which ultimately leads to the localization of points where turbulence causes the most wear on pipes, equipment, or the fluid containment.

Therefore, it is necessary to have a system and method that is not only capable of accurately detecting the areas of greatest turbulence in pipes, equipment, or containers, to precisely identify the areas of greatest impact and wear but also allows for a reduction in installation and operational costs, and facilitates its use in already operational processes. Additionally, there is a need for a solution that allows its use in any location within a piping circuit, in order to detect the areas most prone to wear and failures throughout an entire installation.

This and other advantages associated with other aspects of this technology are described in greater detail below.

### DESCRIPTION OF THE INVENTION

The invention relates to a system and method for modeling the three-dimensional behavior of laminar and turbulent flows in a containment medium in real time, which improves the accuracy in obtaining the velocity field of the fluid, while facilitating its installation and operation.

According to a first preferred embodiment of the invention, the system comprises:
at least one ultrasonic image capture unit, which captures at least a first image and at least a second consecutive image of at least one particle-laden fluid, through at least one of the walls of the fluid containment medium; and
at least one central unit for generating and receiving ultrasonic signals and processing data, which receives the at least one first and second images from the at least one ultrasonic image capture unit;
wherein at least one central unit for generating and receiving ultrasonic signals and processing data obtains at least one radiofrequency value for the at least one first and second images, from which at least one velocity field of the at least one fluid is obtained, through a displacement correlation of said at least one radiofrequency value, said at least one radiofrequency value being adjusted by the Doppler effect, generating at least one validated two-dimensional velocity field in real time; and
wherein the central unit for generating and receiving ultrasonic signals and processing data comprises at least one trained and optimized neural network based on real-time measurements in at least one volume of the at least one fluid, which receives the at least one two-dimensional velocity field to adjust its accuracy, and to model at least one three-dimensional velocity field in real time.

The system of the present invention operates through the acquisition of multiple images by the at least one ultrasonic image capture unit, which are sent to the at least one central unit for generating and receiving ultrasonic signals and processing data, in order to obtain a two-dimensional velocity field, related to the area encompassed in said images. This velocity field is adjusted by at least one neural network, which is previously trained and optimized based on real-time measurements taken from at least one first bounded volume and its respective computational simulation. Thanks to this calibration step of the neural network, it is possible to model at least one three-dimensional velocity field of at least one second volume, which is larger than the first volume used for calibration. This is a substantial difference between the present technology and state-of-the-art solutions, as thanks to the use of neural networks it is possible to accurately obtain the velocity field for areas that are beyond those captured by the ultrasound images, thus allowing for coverage of much larger areas without increasing the cost of the system, while simultaneously increasing accuracy.

From the generation of this three-dimensional velocity field, it is possible to accurately estimate the areas of highest turbulence near the wall, within a piping circuit, process equipment, or the surface of a fluid containment, allowing operators to visualize which points of the facilities need to be monitored for possible preventive or predictive maintenance. Additionally, from the measurements, the concentration of particles and an estimation of the particle size distribution can be obtained, along with the characterization of the fluid.

According to another embodiment of the invention, the at least one ultrasonic image capture unit communicates with the at least one central unit for generating and receiving ultrasonic signals and processing data wirelessly, through at least one data receiving and transmitting unit. Preferably, the at least one central unit for generating and receiving ultrasonic signals and processing data is hosted in a data cloud.

According to another embodiment of the invention, the at least one ultrasonic image capture unit communicates with the at least one central unit for generating and receiving ultrasonic signals and processing data through an information transmission device that connects both units. Preferably, said information transmission device is a data cable.

According to another embodiment of the invention, the at least one ultrasonic image capture unit captures between 0 and 360 images per second.

According to another embodiment of the invention, the at least one central unit for generating and receiving ultrasonic signals and processing data and the at least one trained and optimized neural network model the at least one three-dimensional velocity field using between 2 and 128 flow lines. This is a substantial difference from state-of-the-art solutions, as they generally use only one flow line to perform their calculations, making the present invention provide more precise and reliable results.

According to another embodiment of the invention, the at least one two-dimensional velocity field has an area in the range of 400 mm² to 800 mm², which implies a first volume that is in the range of 7,068.6 mm³ to 14,137.2 mm³.

According to another embodiment of the invention, the at least one three-dimensional velocity field has a second volume that is in the range of 14,137.2 mm³ to 28,274.3 mm³. This characteristic related to the volume of the three-dimensional velocity field is relevant, as it encompasses a much larger space compared to the volume obtained through the at least one first and second images. This is achieved thanks to the work of the at least one neural network, which allows modeling said volume up to a volume much larger than that considered in the at least one first and second images.

According to another embodiment of the invention, the at least one neural network is trained and optimized based on numerical models. Preferably, the at least one neural network is trained with simulations and validated with previous measurements obtained from the fluid.

According to another embodiment of the invention, the at least one analyzed fluid comprises a Reynolds number in the range of laminar and turbulent, up to a Reynolds number of 120,000.

On the other hand, according to a second preferred embodiment of the invention, a method for modeling the three-dimensional behavior of laminar and turbulent flows in a containment medium in real time is also described, which comprises the steps of:
a) capturing at least one first image and at least one second consecutive image of at least one particle-laden fluid, through at least one of the walls of the fluid containment medium using at least one ultrasonic image capture unit;
b) receiving, by at least one central unit for generating and receiving ultrasonic signals and processing data, the at least one first and second images from the at least one ultrasonic image capture unit;
c) obtaining, through at least one central unit for generating and receiving ultrasonic signals and processing data, at least one radiofrequency value for at least one first and second images, from which at least one velocity field of at least one fluid is obtained, through a displacement correlation of said at least one radiofrequency value, being said at least one radiofrequency value adjusted by the Doppler effect, generating at least one validated two-dimensional velocity field in real time; and
d) receiving the at least one two-dimensional velocity field, through at least one neural network trained based on real-time measurements in at least one volume of the at least one fluid, to adjust its accuracy, and to model at least one three-dimensional velocity field in real time.

According to another embodiment of the invention, the method further comprises sending the at least one first and second images from the at least one ultrasonic image capture unit to the at least one central unit for generating and receiving ultrasonic signals and processing data wirelessly, through at least one data receiving and transmitting unit.

According to another embodiment of the invention, the method further comprises sending the at least one first and second images from the at least one ultrasonic image capture unit to the at least one central unit for generating and receiving ultrasonic signals and processing data through an information transmission device, which connects both units.

According to another embodiment of the invention, step a) further comprises capturing between 0 and 360 images per second.

According to another embodiment of the invention, step d) further comprises modeling the at least one three-dimensional velocity field using between 2 and 128 flow lines.

According to another embodiment of the invention, it further comprises training and optimizing the at least one neural network from numerical models.

According to another embodiment of the invention, step c) further comprises making at least one estimation of the concentration and particle size distribution of the at least one fluid.

According to another embodiment of the invention, step d) further comprises detecting at least one area of greater erosion in at least one wall of the containment medium. This feature is relevant in the industry, as it allows process plant operators to early detect areas within the containment medium, which can be a piping circuit or a tank for mining processes, for example, that are exposed to greater wear. This allows for the early initiation of preventive maintenance plans, which help maximize the plant's operating time, reducing corrective maintenance events, which tend to be more costly, both due to the costs of repair materials and labor, as well as the downtime of the plant, which is usually greater than in a preventive maintenance shutdown.

From the above, it is possible to observe that an important difference between the present invention and the solutions of the prior art relates to the fact that the present system, instead of performing its calculations based on only one flow line, uses up to 128 flow lines, which allows for more accurate results for the velocity field. Furthermore, none of the current solutions use a trained and optimized neural network based on real-time measurements of a first fluid volume, which allows the system of the invention to model a three-dimensional velocity field of a volume beyond what is visible through the obtained ultrasound images. Having a three-dimensional velocity field allows for more precise localization of areas of greater turbulence within an industrial process, thus helping operators make better and faster decisions regarding maintenance tasks, for example, by being able to visualize in real time the sections of pipes, equipment, or containers that suffer from greater wear due to turbulence.

On the other hand, the system and method of the invention allows, in a preferred embodiment, to be placed in any location within a process that involves transporting fluids through pipes, which is not feasible with current solutions, which only measure accurately at elbows that may form. The present system can be located both in elbows and in straight pipe sections, without losing accuracy, which allows operators to keep wear under control throughout the entire piping route.

Finally, none of the solutions of the prior art provides a solution that improves the accuracy in obtaining the velocity field, but at the same time does not involve higher costs in the installation or operation of the system. This is mainly because the system comprises equipment that can be adapted to this type of application, which, in combination with the neural network, allows for a leap in quality regarding the measurements and calculations performed.

### BRIEF DESCRIPTION OF THE DRAWINGS

As part of the present invention, the following figures representative thereof are presented, which show preferred configurations of the invention and, therefore, should not be considered as limiting to the definition of the claimed subject matter.

FIG. 1 shows a longitudinal cross-section view of the system for modeling the three-dimensional behavior of laminar and turbulent flows, according to a preferred configuration of the present invention.

FIG. 2 shows a cross-sectional view of the system for modeling the three-dimensional behavior of laminar and turbulent flows, according to a preferred configuration of the present invention.

FIG. 3 shows the operation of the ultrasonic image capture unit and the trained and optimized neural network of the system for modeling the three-dimensional behavior of laminar and turbulent flows, according to a preferred configuration of the present invention.

FIG. 4 shows a block diagram detailing the operation of the system for modeling the three-dimensional behavior of laminar and turbulent flows, according to a preferred configuration of the present invention.

### DETAILED DESCRIPTION OF THE DRAWINGS

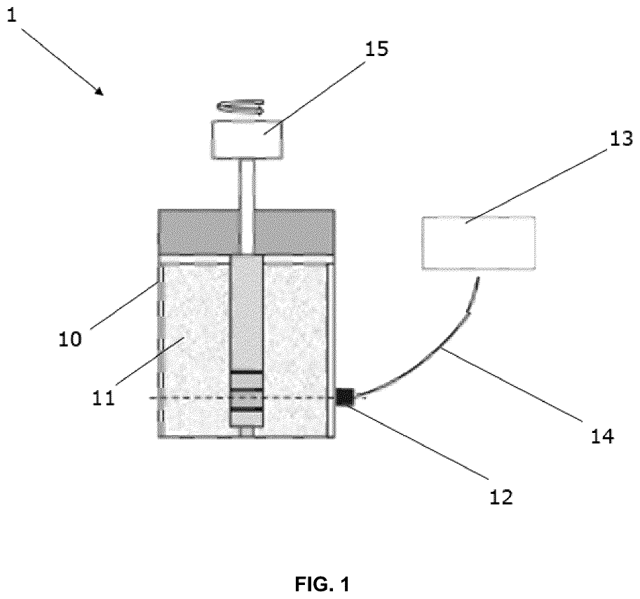

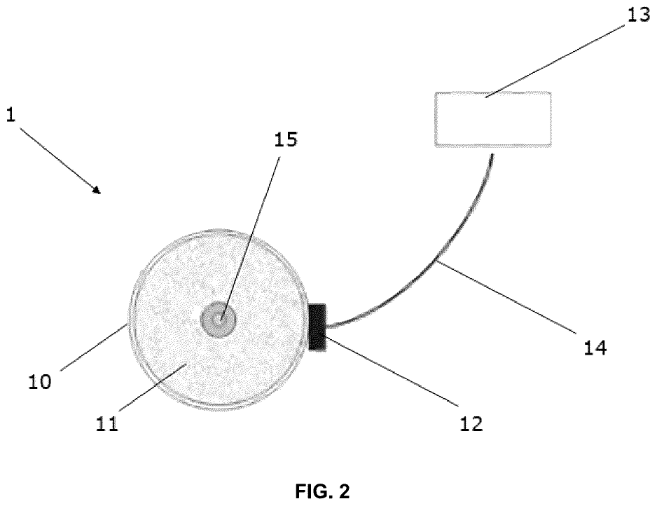

With reference to the accompanying figures, FIGS. 1 and 2 show a longitudinal and cross-sectional view of a containment medium (10), in which the system (1) for modeling the three-dimensional behavior of laminar and turbulent flows of the invention is provided. This arrangement corresponds to an exemplary embodiment carried out in a laboratory, solely for illustrative purposes of the present description, being possible to replicate the system (1) in applications for the mining, food, chemical, and other similar industries, where there is a need to accurately measure the velocity field of the fluid.

Specifically, in FIGS. 1 and 2, the arrangement of a containment medium (10) is observed, in which a particle-laden fluid (11) is disposed, which is moved by a rotor (15), with which different degrees of turbulence for the fluid (11) can be achieved. On the wall of the containment medium (10), an ultrasonic image capture unit is provided, such as a multi-element transducer, which allows capturing images of the fluid (11) through the wall of the containment medium (10). In the exemplary embodiment shown in FIGS. 1 and 2, the captured images are sent through an information transmission device (14), such as a data cable, to a central unit for generating and receiving ultrasonic signals and processing data (13). However, in other embodiments, it is possible for the information to be sent wirelessly through a data receiving and transmitting unit to the central unit for generating and receiving ultrasonic signals and processing data (13). In this regard, the central unit for generating and receiving ultrasonic signals and processing data (13) can be located near the ultrasonic image capture unit (12), remotely from it, or hosted in a data cloud.

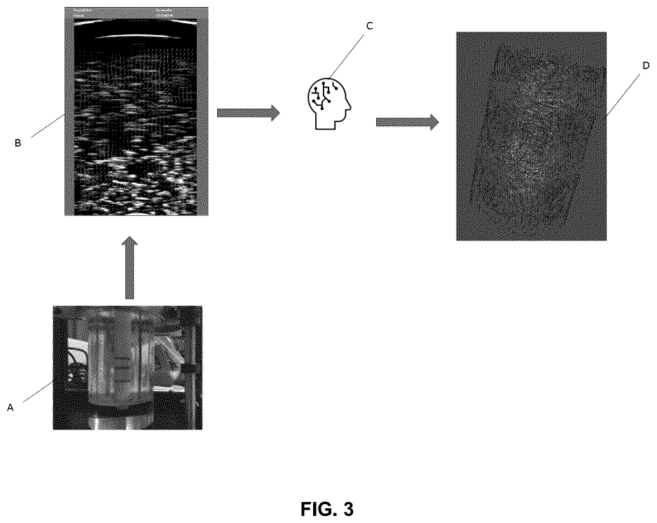

The operation of the system (1) of the invention is observed more clearly in FIG. 3, where four images are shown that describe different stages of the modeling method.

In stage (A), the arrangement of the fluid (11) in a containment medium (10) is observed, in the same way explained in FIGS. 1 and 2. In stage (B), an image of the velocity field in two dimensions is shown, obtained from the images captured by the ultrasonic image capture unit (12). This velocity field is received by a trained and optimized neural network based on real-time measurements in the fluid (11), after which it is capable of extrapolating this received information to model a three-dimensional velocity field for a volume much larger than the initially measured section.

From the modeling of the three-dimensional velocity field, it is possible to obtain more precise data regarding the areas of greatest turbulence within a containment medium, such as an industrial process tank or a pipe. This allows operators of these processes to clearly identify where there will be greater wear due to the fluid's turbulence, which often corresponds to abrasive or corrosive media that can cause weakening of the walls of the containment medium, especially in those areas of greater turbulence. Thanks to the present invention, operators will be able to plan maintenance tasks early, avoiding or reducing corrective maintenance events.

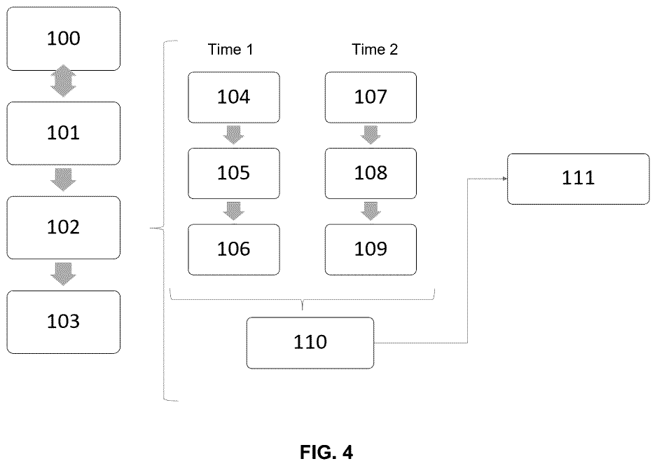

Finally, FIG. 4 shows a block diagram detailing the operation of the system of the invention. Specifically, the blocks (100, 101, 102, 103) are observed, detailing the ultrasonic image capture unit (100), which may correspond to a multi-element ultrasonic transducer TX/RX (transmitted data/received data), the at least one central unit for generating and receiving ultrasonic signals and processing data (101, 102), such as a CPU/GPU (Central Processing Unit/Graphics Processing Unit), which includes generating and receiving ultrasonic signals (101) and processing the received information (102), and a display unit (103), which shows the results through a screen, respectively.

In the data processing stage (102), a series of operations are carried out in a first time, referred to as time 1, and in a second time, referred to as time 2. In time 1, the central unit for generating and receiving ultrasonic signals and processing data processes a first image obtained through the ultrasonic image capture unit, where the radiofrequency signal or value of said first image (104) is analyzed, to obtain the I/Q data (in-phase and quadrature signal data) of said signal, after which the phase shift is measured using FFT (Fast Fourier Transform), to subsequently obtain the velocity decomposition and the velocity field for the first image. After this stage, a first processed image (105) is obtained, concluding with a filtering stage of the velocity field (106) through particle existence zones.

The same stages described for the first image (104, 105, 106) are also carried out in a second time, referred to as time 2, for a second image obtained by the ultrasonic image capture unit, which are correspondingly described in blocks (107, 108, 109).

Upon completing the analysis and processing of the first and second images obtained by the ultrasonic image capture unit, and processed by the central unit for generating and receiving ultrasonic signals and processing data in time 1 and time 2, the validated two-dimensional velocity field (110) is obtained, using ultrasonic particle image velocimetry (Doppler effect), validated through radiofrequency analysis. With this information from the validated velocity field, it is possible to estimate the concentration of particles and their particle size distribution.

Finally, the validated two-dimensional velocity field is analyzed and processed by a pre-trained recurrent neural network with CFD (Computational Fluid Dynamics) results and validated with ultrasonic measurements (111), from which the three-dimensional velocity field in real time is obtained, as well as the areas of greatest wear or erosion in the containment medium due to the turbulence generated in the fluid.

### REFERENCE NUMBERS

1 System for modeling the three-dimensional behavior of laminar and turbulent flows
10 Containment medium
11 Particle-laden fluid
12 Ultrasonic image capture unit
13 Central unit for generating and receiving ultrasonic signals and processing data
14 Information transmission device
15 Rotor

1. A system for modeling the three-dimensional behavior of laminar and turbulent flows in a containment medium in real time, CHARACTERIZED in that it comprises:
at least one ultrasonic image capture unit, which captures at least a first image and at least a second consecutive image of at least one particle-laden fluid, through at least one of the walls of the fluid containment medium; and
at least one central unit for generating and receiving ultrasonic signals and processing data, which receives the at least one first and second images from the at least one ultrasonic image capture unit;
wherein the at least one central unit for generating and receiving ultrasonic signals and processing data obtains at least one radiofrequency value for the at least one first and second images, from which at least one velocity field of the at least one fluid is obtained, through a displacement correlation of said at least one radiofrequency value, said at least one radiofrequency value being adjusted by the Doppler effect, generating at least one validated two-dimensional velocity field in real time; and
wherein the central unit for generating and receiving ultrasonic signals and processing data comprises at least one trained and optimized neural network based on real-time measurements in at least one volume of the at least one fluid, which receives the at least one two-dimensional velocity field to adjust its accuracy, and to model at least one three-dimensional velocity field in real time.

2. The system according to claim 1, CHARACTERIZED in that the at least one ultrasonic image capture unit communicates with the at least one central unit for generating and receiving ultrasonic signals and processing data wirelessly, through at least one data receiving and transmitting unit.

3. The system according to claim 1, CHARACTERIZED in that the at least one ultrasonic image capture unit communicates with the at least one central unit for generating and receiving ultrasonic signals and processing data through an information transmission device, which connects both units.

4. The system according to claim 1, CHARACTERIZED in that the at least one ultrasonic image capture unit captures between 0 and 360 images per second.

5. The system according to claim 1, CHARACTERIZED in that the at least one central unit for generating and receiving ultrasonic signals and processing data and the at least one trained and optimized neural network model the at least one three-dimensional velocity field using between 2 and 128 flow lines.

6. The system according to claim 1, CHARACTERIZED in that the at least one two-dimensional velocity field has an area in the range of 400 mm² to 800 mm², which implies a first volume that is in the range of 7,068.6 mm³ to 14,137.2 mm³.

7. The system according to claim 1, CHARACTERIZED in that the at least one three-dimensional velocity field has a second volume that is in the range of 14,137.2 mm³ to 28,274.3 mm³.

8. The system according to claim 1, CHARACTERIZED in that the at least one neural network is trained and optimized based on numerical models.

9. The system according to claim 1, CHARACTERIZED in that the at least one analyzed fluid comprises a Reynolds number in the range of laminar and turbulent, up to a Reynolds number of 120,000.

10. A method for modeling the three-dimensional behavior of laminar and turbulent flows in a containment medium in real time according to the system of claim 1, CHARACTERIZED in that it comprises the steps of:
a) capturing at least a first image and at least a second consecutive image of at least one particle-laden fluid, through at least one of the walls of the fluid containment medium by means of at least one ultrasonic image capture unit;
b) receiving, by at least one central unit for generating and receiving ultrasonic signals and processing data, the at least one first and second images from the at least one ultrasonic image capture unit;
c) obtaining, by means of the at least one central unit for generating and receiving ultrasonic signals and processing data, at least one radiofrequency value for the at least one first and second images, from which at least one velocity field of the at least one fluid is obtained, through a displacement correlation of said at least one radiofrequency value, said at least one radiofrequency value being adjusted by the Doppler effect, generating at least one validated two-dimensional velocity field in real time; and
d) receiving the at least one two-dimensional velocity field, by means of at least one neural network trained based on real-time measurements in at least one volume of the at least one fluid, to adjust its accuracy, and to model at least one three-dimensional velocity field in real time.

11. The method according to claim 10, CHARACTERIZED in that it further comprises sending the at least one first and second images from the at least one ultrasonic image capture unit to the at least one central unit for generating and receiving ultrasonic signals and processing data wirelessly, through at least one data receiving and transmitting unit.

12. The method according to claim 10, CHARACTERIZED in that it further comprises sending the at least one first and second images from the at least one ultrasonic image capture unit to the at least one central unit for generating and receiving ultrasonic signals and processing data through an information transmission device, which connects both units.

13. The method according to claim 10, CHARACTERIZED in that step a) further comprises capturing between 0 and 360 images per second.

14. The method according to claim 10, CHARACTERIZED in that step d) further comprises modeling the at least one three-dimensional velocity field using between 2 and 128 flow lines.

15. The method according to claim 10, CHARACTERIZED in that it further comprises training and optimizing the at least one neural network from numerical models.

16. The method according to claim 10, CHARACTERIZED in that step c) further comprises performing at least one estimation of the concentration and particle size distribution of the at least one fluid.

17. The method according to claim 10, CHARACTERIZED in that step d) further comprises detecting at least one area of greater erosion on at least one wall of the containment medium.
